(19) United States
(12) Patent Application Publication
(10) Pub. No.: US 2015/0282474 A1
(43) Pub. Date: Oct. 8, 2015

(54) ANTI-SOILING COVER

(71) Applicant: John Edwin Arthur Lockwood, Kingston (CA)

(72) Inventor: John Edwin Arthur Lockwood, Kingston (CA)

(21) Appl. No.: 14/245,028

(22) Filed: Apr. 4, 2014

(51) Int. Cl. A01M 31/00

(52) U.S. Cl. CPC A01M 31/00

(57) ABSTRACT

The anti-soiling covering is made from a plastic that once placed over a dead game bird head and neck prevents blood and body fluids from that dead game bird from leaking out and damaging the hunter's clothing or carpeting in the hunter's vehicle while the game is being transported. The user simply places the device over the beak portion and rolls it over the head and neck region. The device also protects the head and neck portion from feather damage as well as the remainder of the fowl to ensure a quality specimen for mounting.

### BACKGROUND OF THE INVENTION

Game carry devices are not new to the art. In U.S. Pat. No. 8,454,236 entitled “Bag for Storing and Transporting Game and Meat”, issued to Ramirez on Jun. 4, 2013 teaches a game bag with an open mouth ringed by a drawstring passage. Suspending loops are sewn into stitching forming the drawstring passage and are positioned near the opposite side edges of the bag. Light reflective loops are carried at a side edge and in a bottom seam near an opposite edge. This device is simple in that you place the game item within its confines and pull the drawstrings tight.

The present device is even simpler to use because the device is simply placed over the turkeys beak and unrolled over its head and into the neck area covering the wound and preventing any blood from seeping out of the anti-soil covering. The prior art device allows for blood to collect in the bottom of the bag potentially ruining the bird for mounting purposes.

In U.S. Pat. No. 5,467,907 entitled, “Turkey Tote” issued to Celik on Nov. 21, 1995 teaches a hunter's personal safety game pack and method of making it. The game pack is especially designed for the wild turkey, with a blood proof bottom pouch, a No-see-Um mesh drawstring bag top, and shoulder harness. The game pack suggests it solves multiple problems including anti-spoilage, anti tick barrier, and hiding the turkey for other hunters to prevent accidents. This prior art device fails in regard to spoilage just from the fact that it is placed within, a receptacle accelerating heating.

The present invention resolves all the issues recognized by this prior art with a greater utility, instead of hiding the harvested turkey in a bag the harvested turkey is carried in the open air reducing the possibility of spoilage. The prior art also traps the blood in the bottom of the pack or bag once again creating the possibility for damaging the mount itself. Also the anti-soiling covering is made of a highly visible color as to alert other hunters of the presences of the device on a harvested turkey. This allows the hunter to carry the harvested turkey openly at the same time increasing safety because of the increased visibility.

It is clear that the present invention has a greater utility over any prior art in that it covers the head portion of the wild turkey or other game birds or fowl. The anti-soiling cover covers the head and neck and if the hunter is effective in shooting the fowl it will have the majority of the damage in the head and neck region. The anti-soiling device rolls over the head and neck and provides a tight seal and protects the hunter's cloths from blood stain. Also the high visibility colors adds an extra element of safety not found in any of the other prior art.

The present invention also presents huge utility over the entire prior art in that it is extremely convenient for the hunter to carry into the field. It simply fits into the hunter's pocket. The prior art articles are large and cumbersome requiring the hunter to carry them. The hunter is thus limited to what he can carry because of the size of prior art articles. The present device or multiple devices can simply be placed into a pocket and utilized when needed. The hunter could easily have a number of the anti-soiling covers on him at any given time and not impede his ability to carry other objects such as weapons, blinds, decoys, calls or even stands into the field.

### THE INVENTION

The present invention is an anti-soil covering for dead, game birds. The anti-soiling covering is comprised of a flexible tube that has a first end that is open and a second end that is closed. The second closed end has a narrow, closed segment projecting from the second closed end.

### BRIEF DESCRIPTION OF THE DRAWINGS

FIG. 1 shows the anti-soiling device deployed on a turkey.

FIG. 2 shows the anti-soiling device from the top.

FIG. 3 shows the anti-soiling device from the side.

FIG. 4 shows the anti-soiling device pre deployment.

FIG. 5 shows the anti-soiling device being deployed.

FIG. 6 shows the anti-soiling device deployed.

### DETAILED DESCRIPTION OF THE DRAWINGS

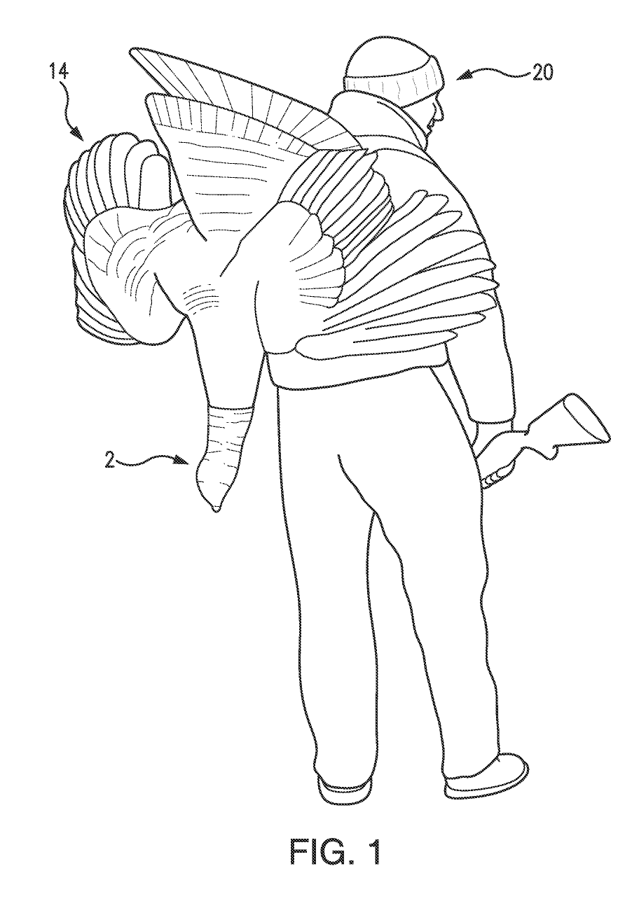

FIG. 1 shows the anti-soiling device 2 deployed on a turkey 14. The anti-soiling covering device has been deployed and the hunter 20 is exiting the field with no blood dripping on his hunting clothes. The high visible color provides added safety letting other hunters know that this bird has been harvested and is being carried from the field.

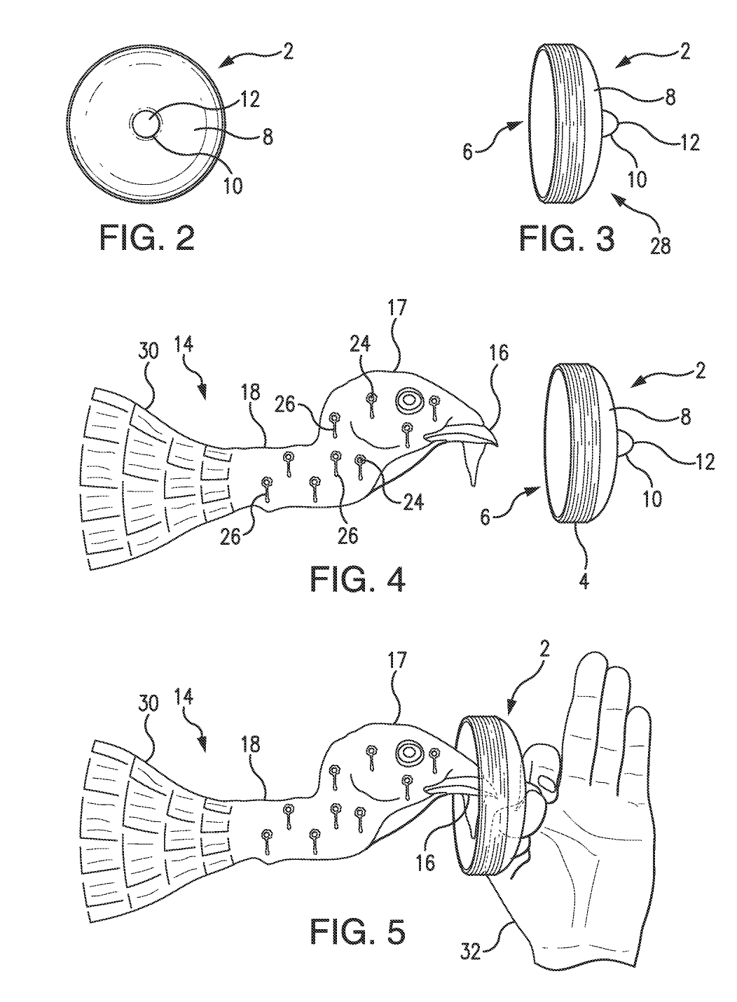

FIG. 2 shows the anti-soiling device 2 from the top or second closed end 8. This closed end 8 has the narrowing end 10 and the closed segment 12. This portion of the device 2 is configured to accept the beak of the turkey or wild fowl.

FIG. 3 shows the anti-soiling device 2 from the side 28. This view shows the closed end or top 8, the narrowing 10 and the closed segment 12. It is clear from this view that the beak fits into the narrow 10 and further into the closed segment 12. This portion is specifically configured to accept the sharp beak portion of a turkey or other wild fowl.

FIG. 4 shows the anti-soiling device 2 pre-deployment. The turkey 14 has been harvested and exhibits pellet wounds 24 and blood seepage 26. The anti-soiling covering 2 has an open end or first end 6 and a second closed end 8. The closed end 6 has a narrowing portion 10 and a closed segment 12. The narrowing portion 10 and closed segment 12 are configured to accept a beak 16. The flexible tube portion 4 is rolled up closer to the closed end 8. The anti-soiling device 2 is unrolled at the flexible tube 4 over the beak 16, head 17 and onto the neck 18 all the way to the body 30.

FIG. 5 shows the anti-soiling device 2 being deployed. The hunter 20 uses his hand 32 to grasp the device 2 and maneuver it over the beak 16. He continue by moving the device 2 further along the turkey 14 passing the head 17 over the neck 18 all the way to the body 30 covering all the pellet wounds 24 and blood seepage 26 from the head shot delivered to the turkey 14.

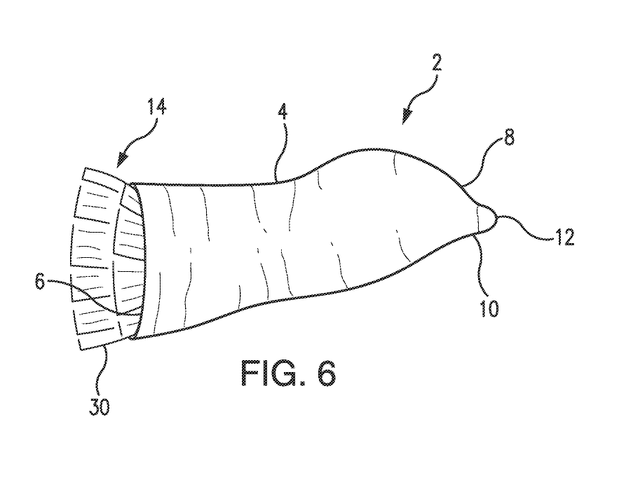

FIG. 6 shows the anti-soiling device 2 deployed. Here it is clear how the flexible tube 4 unfolds to create a protective covering. It is also clear that the first end or open end 6 goes over the beak 16, head 17 and neck 18 to the body 30 of the turkey 14. It is also clear that the closed segment 12 accommodates the beak 17. At the same time the narrowing segment 10 accepts the beak 16 near the head 17. This all takes place at the closed end 8.

The use of the anti-soiling device is a method of providing soiling protection when transporting a dead, game bird. This method comprises providing an anti-soil covering and inserting a head of a dead, game bird in the opening of the first end until a beak of the head of the small game bird touches an inside of the narrow, closed segment projecting from the second closed end.

The user then grasps the narrow, closed segment projecting from the closed end simultaneously with the beak and thereafter extending the flexible tube down around the head and around a neck of the dead, game bird.

The device is manufactured from plastic with a high visibility color. That plastic includes silicone, latex and polyurethane. The device can also be manufactured from nylon. The material of manufacture is important because the device 2 should be flexible enough to roll over the fowl but still remain elasticized to form a tight fit over the beak, head and neck to prevent leakage of fluids from the wounds. The high visibility color is a safety factor in that the fowl can be removed from the field with other hunter's recognizing that this is a harvested bird and will not attempt to harvest it potentially injuring the hunter transporting the bird from the field.

What is claimed is:

1. An anti-soil covering for dead, game birds, said anti-soiling covering comprising a flexible tube having a first end that is open and a second end that is closed; said second closed end having a narrow, closed segment projecting from said second closed end.

2. A method of providing soiling protection when transporting a dead, game bird, said method comprising;
providing an anti-soil covering as claimed in claim 1;
inserting a head of a dead, game bird in said opening of said first end until a beak of said head of said small game bird touches an inside of said narrow, closed segment projecting from said second closed end;
grasping said narrow, closed segment projecting from said closed end simultaneously with said beak and thereafter extending said flexible tube down around said head and around a neck of said dead, game bird.

3. An anti-soil covering for dead, game birds as claimed in claim 1, wherein said anti-soiling covering is made of material having a high visibility color.

4. An anti-soil covering for dead, game birds as claimed in claim 1, wherein said anti-soiling covering is made from plastic.

5. An anti-soil covering for dead, game birds as claimed in claim 1, wherein said anti-soling covering is made from nylon.

6. An anti-soil covering for dead, game birds as claimed in claim 1, wherein said anti-soiling covering is made from silicone rubber.

7. An anti-soil covering for dead, game birds as claimed in claim 1, wherein said anti-soiling covering is made from polyurethane.

8. An anti-soil covering for dead, game birds as claimed in claim 1, wherein said anti-soiling covering is made from latex.
